(19) United States
(12) Patent Application Publication
(10) Pub. No.: US 2014/0351103 A1
(43) Pub. Date: Nov. 27, 2014

(54) RECONCILIATION SYSTEM IN MANAGERIAL SUBSIDIARIES

(71) Applicant: Blackbaud Incorporated, Charleston, SC (US)

(72) Inventors: Andrew Payne, Wadmalaw Island, SC (US); Antonio Drusin, Charleston, SC (US)

(21) Appl. No.: 13/899,756

(22) Filed: May 22, 2013

(51) Int. Cl. G06Q 40/00; G06Q 30/02

(52) U.S. Cl. CPC G06Q 40/12; G06Q 30/0279
USPC 705/30

(57) ABSTRACT

A method and system for financial reconciliation automation in managerial subsidiaries through system accounting controls. The embodiments of the present disclosure solve systemic organizational accounting problems by supporting transactional integrity, allowing for separate revenue valuations by function, instilling parallel control models throughout a client implementation, and decoupling ancillary concerns from an organization's revenue recognition. An accounting reconciliation system may be configured to execute logic operable to receive a data input; execute a valuation according to data input and accounting and managerial control logic; identify a reconciling item by evaluating a managerial valuation calculated by the revenue and receivables consuming application and executing over a DTM; and, select treatment of the reconciling item by enabling an administrative user to select a reconciling action over a graphical user interface executing over an administrator reconciliation application.

### FIELD

The embodiments of the present disclosure generally relate to managerial accounting in a non-profit organization. More particularly, the embodiments of the present disclosure relate to computer systems for reconciliation automation in managerial subsidiaries through system accounting controls.

### BACKGROUND

Nonprofit organizations may utilize a number of financial accounting methodologies based on balancing managerial flexibility with standardized financial reporting requirements. Different departments in an organization may choose different financial accounting methodologies depending on defined managerial relevance. Typical accounting methodologies include Generally Accepted Accounting Principles (GAAP) or accrual basis, modified cash basis, and cash basis.

GAAP basis requires accruals. Recording receivables and accrued expenses in the period in which they were incurred supports the matching concept (matching revenues and expenses in the same period). Because GAAP basis has definite “rules” about how and when to record transactions, financial statements prepared on this basis can be compared to financial statements of other organizations on GAAP basis. Some nonprofit organizations maintain their monthly financial records on a modified cash basis internally for budgeting purposes, and then convert to the accrual basis at year-end so that their fiscal year-end financial statements are in accordance with GAAP.

Under the cash basis, organizations recognize a transaction when there is either incoming cash or outgoing cash; thus, the receipt of cash from a donor triggers the recordation of revenue, while the payment of a supplier triggers the recordation of an asset or expense. Under the accrual basis, an organization records revenue when it is earned and expenses when they are incurred, irrespective of any changes in cash.

The modified cash basis establishes a position part way between the cash and accrual methods. The modified basis has the following features: records short-term items when cash levels change (the cash basis). This means that nearly all elements of the income statement are recorded using the cash basis, and that accounts receivable and inventory are not recorded in the balance sheet. This means that fixed assets and long-term debt are recorded on the balance sheet, and depreciation and amortization in the income statement.

There are no exact specifications for what is allowed under the modified cash basis, since it has developed through common usage. There is no accounting standard that has imposed any rules on its usage. If the modified cash basis is used, transactions should be handled in the same manner on a consistent basis, so the resulting financial statements are comparable over time.

Each of these methodologies has benefits and disadvantages depending on the managerial considerations at play. Where managerial flexibility is favored in place of transactional integrity, significant financial discrepancies can arise between internal departmental accounting. These discrepancies can have significant and compounding effects across organizations of mass in the form of reconciling accounting items with uncertain origins or uniform resolutions. No system exists to allow managerial flexibility in program specific accounting systems, while maintaining transactional integrity across competing interdepartmental valuations. What is needed, therefore, is a system that delivers high transactional integrity while allowing for managerial accounting flexibility regardless of modified cash basis accounting methodology and ancillary concerns.

### SUMMARY

An object of the present invention is a computer-implemented method for maintaining transactional integrity across managerial financial accounting applications, the method comprising receiving a data input corresponding to a transaction event, the data input being stored in a database; executing a function-specific valuation based on the data input corresponding to the transaction event, the valuation being executed on a processor according to function-specific control business logic stored on a computer-readable medium, the function-specific control business logic being adapted to execute accounting controls and managerial controls; identifying an instance of a reconciling item by comparing valuation outcomes between the function-specific control business logic and the accounting controls, the reconciling item being indexed in a database; and, enabling a user to determine treatment of a reconciling item based on defined treatment parameters.

Another object of the present invention is a system for preserving transactional integrity for managerial flexibility in financial accounting applications, the system comprising a memory device configured to store a data input corresponding with at least one transaction event, the memory device further configured to store and index reconciling items; a processing device executing over one or more web servers configured to execute procedures of a managerial accounting integrity module, the module including logic configured to execute a valuation by function based upon the data input corresponding to the at least one transaction event, the function-specific control business logic being adapted to execute accounting controls and managerial controls; logic configured to identify an instance of a reconciling item by comparing valuation outcomes between the function-specific control business logic and the accounting controls; and, logic configured to determine a reconciling item outcome in response to a user input.

Yet another object of the present invention is a computer-readable media having financial reconciliation instructions stored thereon for preserving transactional integrity in managerial accounting applications, the financial reconciliation instructions being executable by a processor, the financial reconciliation instructions comprising logic adapted to execute a plurality of function-specific valuations, the plurality of function-specific valuations being defined by a data input corresponding to a transaction event and control business logic, the control business logic being adapted to execute managerial and accounting control valuations; logic adapted to identify reconciling items across the plurality of function-specific valuations, the reconciling items being identified by comparing control business logic outcomes against managerial control valuation outcomes; and, logic adapted to enable a user to view and act upon identified reconciling items such that the user may select a treatment outcome for the identified reconciling items, and may update relevant portions of the control business logic in response to statistically significant recurring reconciling items.

Further embodiments, features, and advantages of the invention, as well as the structure and operation of the various embodiments of the invention are described in detail below with reference to the accompanying drawings.

### BRIEF DESCRIPTION OF DRAWINGS

The components of the following figures are illustrated to emphasize the general principles of the present disclosure. Reference characters designating corresponding components are repeated as necessary throughout the figures for the sake of consistency and clarity.

FIG. 1 is a block diagram of an accounting reconciliation system in accordance with an embodiment.

FIG. 2 is a block diagram of an accounting reconciliation system in accordance with an embodiment.

FIG. 3 is a logical flow diagram illustrating an accounting reconciliation system in accordance with an embodiment.

FIG. 4 is logical flow diagram illustrating a routine of an accounting reconciliation system in accordance with an embodiment.

FIG. 5 is logical flow diagram illustrating a routine of an accounting reconciliation system in accordance with an embodiment.

FIG. 6 is logical flow diagram illustrating a routine of an accounting reconciliation system in accordance with an embodiment.

FIG. 7 is logical flow diagram illustrating a routine of an accounting reconciliation system in accordance with an embodiment.

FIG. 8 is a diagram of a graphical user interface (GUI) for viewing function-based valuations across an accounting reconciliation system in accordance with an embodiment.

FIG. 9 is a diagram of a GUI for accepting a credit card donation over the Internet.

FIG. 10 is a diagram of a GUI for viewing an index of transaction events in an accounting reconciliation system in accordance with an embodiment.

FIG. 11 is a diagram of a GUI for electing an action for a reconciling item in an accounting reconciliation system in accordance with an embodiment.

FIG. 12 is a diagram of a GUI for an agent payout approval in an accounting reconciliation system in accordance with an embodiment.

FIG. 13 is a diagram of a GUI illustrating a payout batch summary in an accounting reconciliation system in accordance with an embodiment.

FIG. 14 is a diagram of a GUI illustrating a comprehensive charity batch in an accounting reconciliation system in accordance with an embodiment.

### DETAILED DESCRIPTION

Reference will now be made in detail to various embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of various embodiments of the present invention, numerous specific details are set forth in order to provide a thorough understanding of the present invention. In other instances, well-known methods, procedures, protocols, services, components, and circuits have not been described in detail so as not to unnecessarily obscure aspects of the present invention.

The embodiments of the present disclosure describe systems and methods for preserving transactional integrity in an organization, while allowing for managerial flexibility among different departments within the organization. This model may be especially valuable in the context of non-profit organizations, although it is anticipated that it is equally beneficial in any organization that allocates separate valuations for revenue between organizational departments. Illustrative examples in the present disclosure use a hypothetical non-profit organization to demonstrate the functional elements of the present systems and methods. These examples are not meant to limit the scope of the present disclosure, but are rather meant to illustrate the elements of the embodiments such that the descriptions of their implementation are not unnecessarily obscured. The embodiments of the present disclosure solve systemic organizational accounting problems by supporting transactional integrity, allowing for separate revenue valuations by function, instilling parallel control models throughout a client implementation, and decoupling ancillary concerns from an organization's revenue recognition.

As used throughout the present disclosure, the terms “financial transaction,” “revenue event,” “transaction event,” and “transaction” as defined in the present disclosure, may relate to any suitable transactions, such as, for example, donation, deposits, withdrawals, grant award, pledge, recurring gift, planned gift, matching gift claim, challenge gift claim, ticket sales, sponsorship, membership fees, merchandise sales, auction purchase, fees for services rendered, and the like. A financial transaction may produce a number of non-cash or near-cash transactions that may be relevant for reconciliation issues in the context of the present disclosure, such as, for example, credit card, automated clearing house (ACH), third party payment processors, stock, and gift-in-kind. In the context of the present disclosure, these transactions may constitute ancillary concerns; the embodiments of the present disclosure will resolve the resulting reconciliation issues in these contexts as well. The term “client” may refer to a company, organization, business, corporation, enterprise, government agency, department, group, family, individual, and the like. Other implementations, benefits, and advantages will become apparent to one of ordinary skill in the art from an understanding of the embodiments of the present disclosure. The term “reconciliation” may be defined as an accounting process used to compare two sets of records to ensure the figures are in agreement and are accurate. Reconciliation is the key process used to determine whether the money leaving an account matches the amount spent, ensuring that the two values are balanced at the end of the recording period. The term “reconciling item” may be defined as a data point that creates a mismatch between two sets of records such that the records are not in agreement and/or are inaccurate.

The following may serve as an illustrative illustration of these organizational accounting problems without the benefit of embodiments of the present disclosure; a fundraiser in a non-profit organization enters a donation near fiscal year end. An accounting staff member closes the fiscal year to prepare for a financial statement audit. A donor calls to inform the fundraiser that a $10,000 donation was receipted for only $1,000. The fundraiser corrects the donation in the already closed fiscal period. The accountant attempts to post from the fundraising system, only to find that the several transactions fail validation in the accounting system due to the closed fiscal period rule. The accountant alters the file to account for the fundraising changes and processes the post. As a result, the fundraising and accounting reports no longer match due to the donation corrections in the closed fiscal year.

Using the above illustration as applied to the embodiments of the present disclosure; a fundraiser enters a donation near fiscal year end. An accounting staff member closes the year to prepare for the financial statement audit. A donor calls to inform the fundraiser that a $10,000 donation was receipted for only $1,000. The fundraiser corrects the donation in the closed fiscal period. According to an embodiment, the present system stores the fundraising value in the prior fiscal year and the accounting result on the date of correction. The accountant notices the presence of a reconciling item, reviews it, and selects an option that suggests that both the fundraising and accounting needs are different but legitimate. As a result, the fundraising and accounting reports no longer match but those reconciling items are highlighted to explain the differences.

The following illustrates a scenario of the application of dynamic managerial controls as evaluated by accounting controls to track a reconciling item. According to an illustrative example of an implementation of an embodiment of the present disclosure, a fundraising user enters a pledge agreement into an accounting reconciliation system to demonstrate a $10,000 pledge donation to an educational institution to benefit its library. The pledge is due in two installments, in this example May 15, 2014 and May 15, 2015. The donor remits the first installment on May 15, 2014, but asks that the payment be allocated as follows: $2,000 to the institution's football team and $3,000 to the library. The fundraiser obliges the donor and enters the payment as requested. The system highlights a reconciling item was introduced as the accountant would expect the entire pledge to go to the library. The accountant sees the reconciling item flag exists, investigates the scenario, and rejects the fundraising position. The system executes a series of events, including an automated notification to the Executive Director and Vice President of Development so that the situation can be reconsidered. The management agrees with the accounting staff and the Executive Director contacts the donor to explain why the scenario is unacceptable.

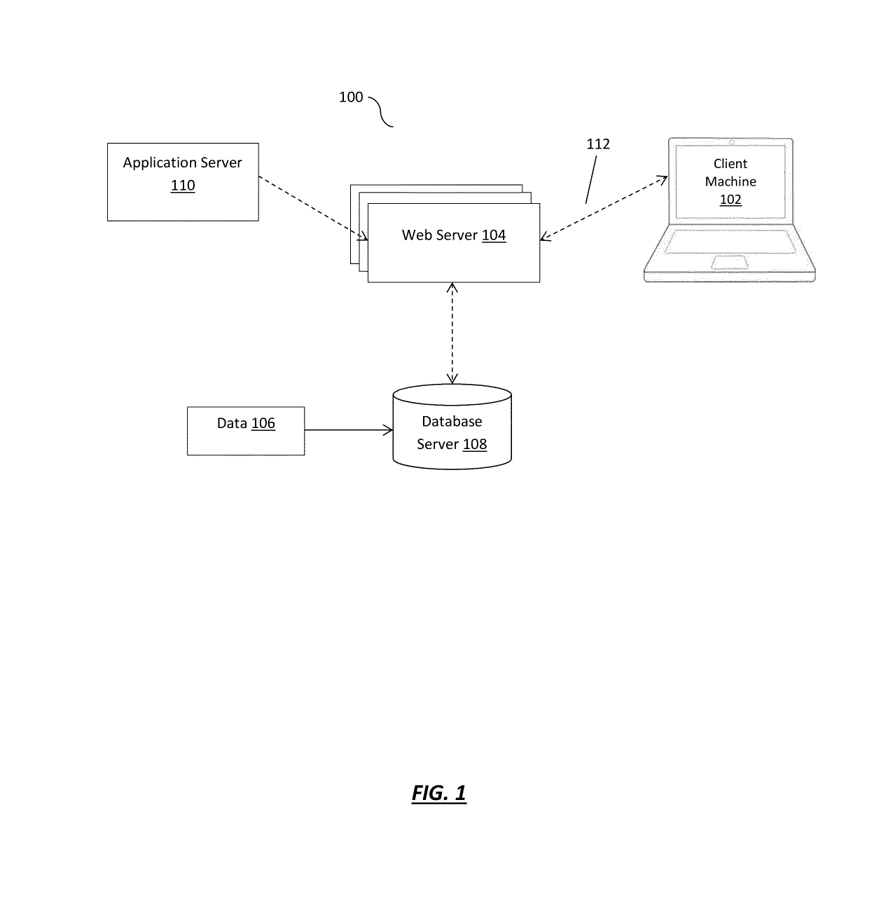

FIG. 1 is a block diagram of an accounting reconciliation system in accordance with an embodiment. Accounting reconciliation system 100 represents an embodiment by which a client organization may promote transactional integrity across disparate inter-departmental financial accounting methodologies. Client machine 102 may represent any type of computing system and may be connected to one or more networks associated with the client organization.

In an embodiment, client machine 102 includes a processing device, memory device, input/output (I/O) devices, and a network interface 112, each interconnected via a bus. The processing device may be a general-purpose of a specific purpose processor or microcontroller. The memory device may include one or more internally fixed storage units, removable storage units, and/or remotely accessible storage units. The storage units can be configured to store information, data, instructions, and/or software code. The storage units may include any combination of volatile memory, such as random access memory (RAM), dynamic RAM (DRAM), and/or non-volatile memory, such as read only memory (ROM), electrically erasable programmable ROM (EE-PROM), flash memory, and the like.

Database server 108 and application server 110 may be of the same form as client machine 102, and may store program code that enables the processing device to execute accounting reconciliation procedures. Various logical instructions or commands may be included in the program code for reconciling financial transactions. The embodiments of the reconciliations procedures described in the present disclosure can be implemented in hardware, software, firmware or a combination thereof. When implemented in software or firmware, the reconciliation procedures or algorithms can be stored in the memory device and executed by the processing device.

Database server 108 may be configured to receive and store a data input 106 corresponding to one or more transactions. Reconciliation algorithms, programs, or software, which can be partially or fully in a memory device on one or more of database server 108, application server 110, and client machine 102, and any other computer code including executable logical instructions as described herein, can be embodied in computer-readable media for execution by any suitable processing device. The computer-readable media as described herein can include one or more suitable physical media components that can store the software, programs, or computer code.

I/O devices may include input mechanisms such as keyboards, keypads, cursor control devices, or other data entry devices. The input mechanisms may be used for entering set-up information for establishing matching rules and reconciliation rules. Input mechanisms may also be used to initiate financial reconciliation procedures and to access the results of financial reconciliation procedures. I/O devices also include output devices, which may be computer monitors, audio output devices, printers, and/or other peripheral devices. Network interface 112 includes components for accessing a network, such as a data network or an accounting network related to a client organization's financial accounts or financial records.

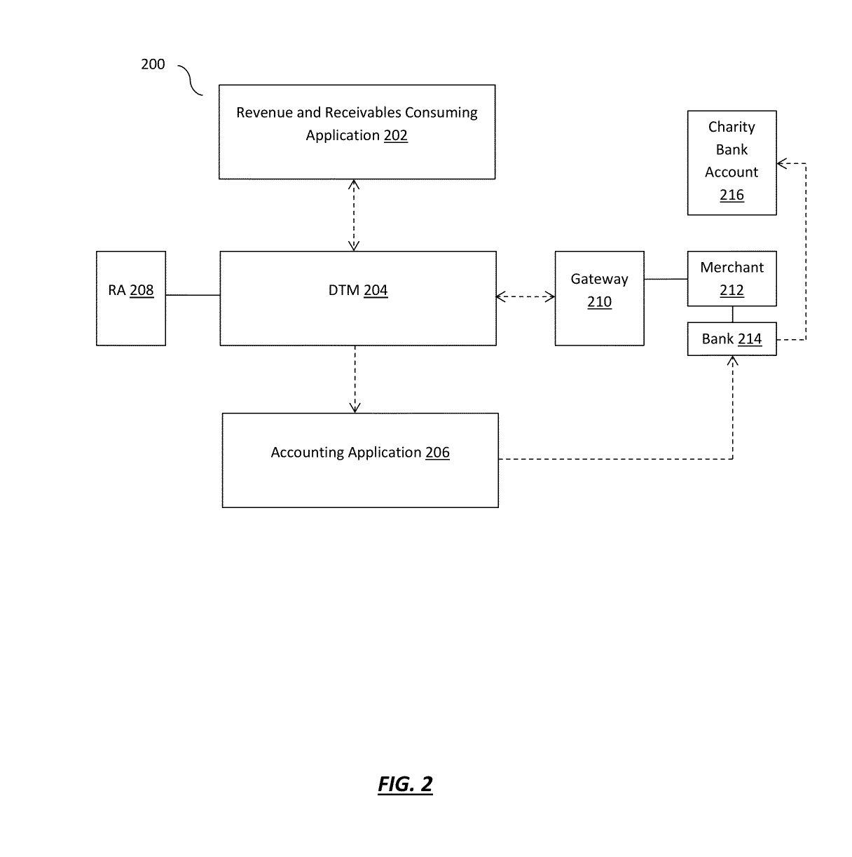

FIG. 2 is a block diagram of an accounting reconciliation system in accordance with an embodiment. In an embodiment, accounting reconciliation system 200 is configured to reconcile managerial behavior against accounting controls across a client organization. A data transfer mechanism (DTM) 204 may function to communicate data inputs across revenue and receivables consuming application 202, accounting application 206, administrative reconciling application 208, and a merchant gateway 210.

In an embodiment, revenue and receivables consuming application 202 is configured to execute logic over one or more processing units to reconcile managerial behavior to an accounting system, such that a reconciling item is generated in the event of a disconnect between DTM 204 accepted results and/or managerial inputs inconsistent with an accepted accounting pattern and/or two or more sets of organizational financial records stored in DTM 204. DTM 204 and merchant gateway 210 may be configured such that DTM 204 may reconcile transactions being stored across gateway 210. A reconciling item may be generated for gateway state transitions outside a DTM accepted pattern. A merchant 212 may handle or provide transaction and data processing between a bank 214 and gateway 210. Accounting application 206 may be configured to receive financial data from DTM 204 and post subsidiary results to a general ledger, which may represent the Accounting View of the financial data. In an embodiment, the Accounting View is the accounting user display to view financial data in accordance with accounting controls. The accounting control valuations are determined by the client organization, and may be configured as accrual or cash basis valuations. Accepted Reconciling Differences may be available in all subsequent transactional reports to illustrate the differences between the general ledger and reconciling differences.

In an embodiment, an Administrator Reconciliation Application 208 is configured to execute reconciliation logic according to financial items stored in DTM 204. Administrator Reconciliation Application 208 is configured to resolve managerial reconciling items identified from accounting controls. A managerial user can act upon managerial reconciliation items over an interface module to 1) accept the managerial result by restating the accounting view; 2) accept the accounting result by restating the managerial result; or 3) approve the reconciling item as a legitimate difference. Administrator Reconciliation Application is also configured to resolve a gateway 210 transition according to defined state transition reconciling items with DTM 204.

In an embodiment, accounting reconciliation system 200 is configured to reconcile vendor transactions for eventual disbursement to charity customers. In this embodiment, revenue and receivables consuming application 202 is configured to accept a donation entry from a donor. The donation entry is inputted to DTM 204, which may evaluate the donation input against an expected transactional result. Expected transactional results may form the basis for control variables in DTM 204, which may produce a reconciling item for any observed event resulting in a state inconsistent with the control. In this scenario, this “expected result” may the first of two classes of reconciling item. The second reconciling item may result where DTM 204 compares payment gateway 210 suggested payment states to DTM 204 payment state controls. DTM 204 may produce a reconciling item for any observed event resulting in a gateway transaction state change inconsistent with the suggested DTM control state. Reconciling application 208 may function to tag all reconciling items with DTM 204 and offer the administrative user the option to resolve all identified reconciling items in a graphical user interface prior to charity disbursement. Donation input from revenue and receivables consuming application 202 and payment gateway 210 may be communicated from DTM 204 to accounting application 206 which may function as an agent general ledger and payables application. The funds held by agent general ledger and payables accounting application 206 may be transferred by the agent's accounts payable to the agent's bank 214 for distribution and transfer to charity bank account 216.

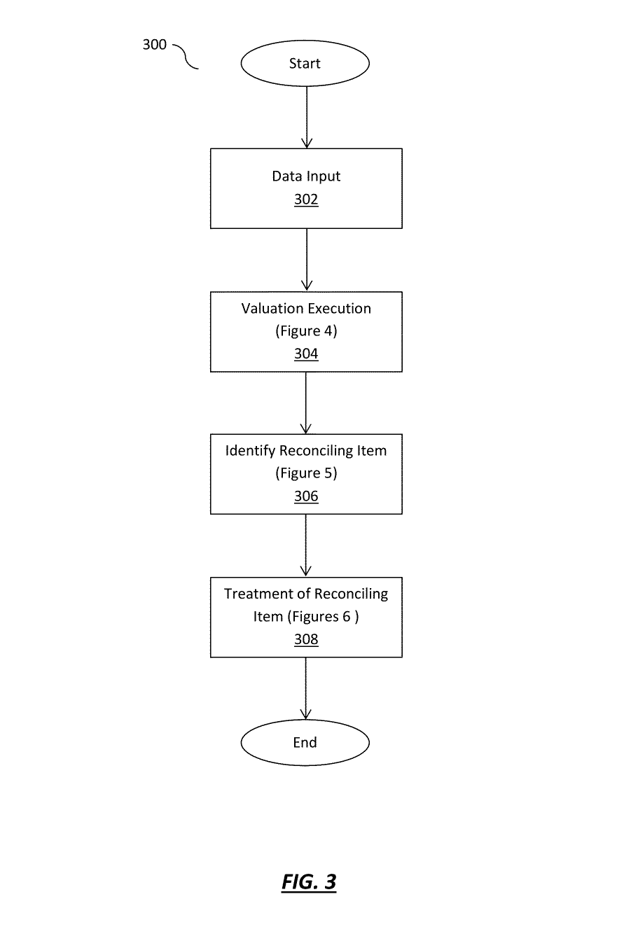

FIG. 3 is a logical flow diagram illustrating an accounting reconciliation system in accordance with an embodiment. According to this embodiment, an accounting reconciliation system 300 is configured to execute logic operable to receive a data input 302, the data input corresponding to a financial transaction and being stored in a DTM or data server; execute a valuation 304 according to data input 302 and accounting and managerial control logic executed by at least one processing unit configured to execute a revenue and receivables consuming application module and an accounting application module; identify a reconciling item by evaluating a managerial valuation calculated by the revenue and receivables consuming application and executing over the DTM; and, select treatment of the reconciling item by enabling an administrative user to select a reconciling action over a graphical user interface executing over an administrator reconciliation application.

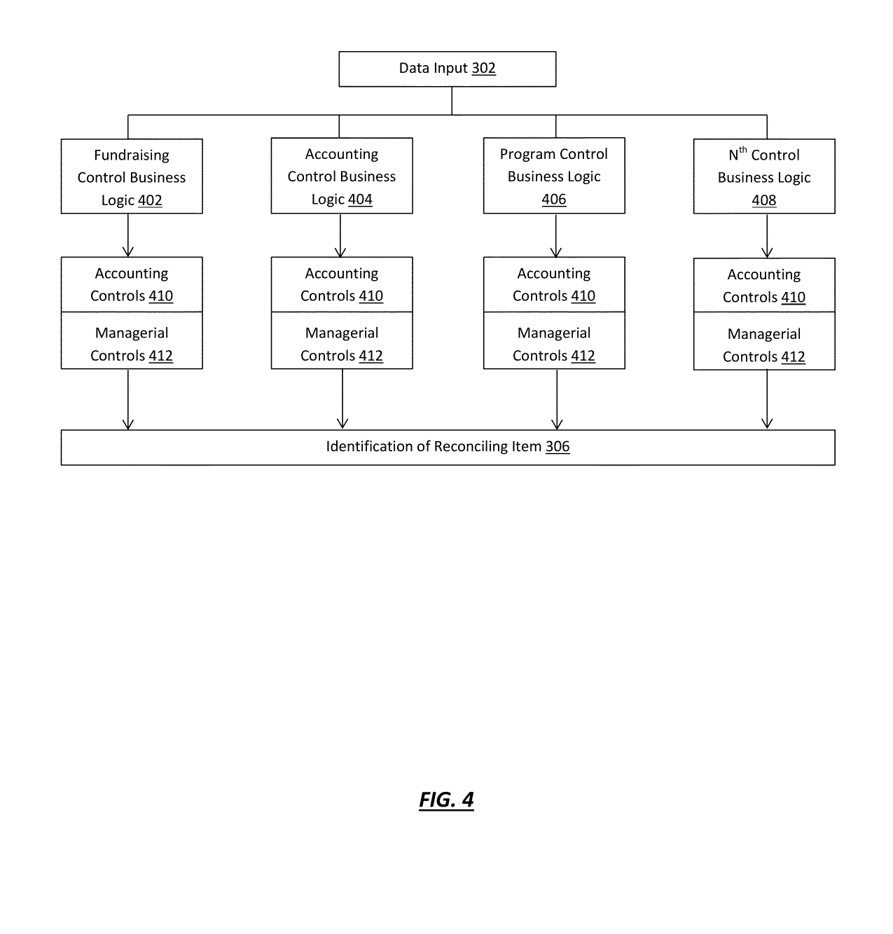

FIG. 4 is a logical flow diagram illustrating a routine of an accounting reconciliation system in accordance with an embodiment. In accordance with this embodiment, a data input 302 corresponding to a financial transaction is stored in a DTM or data server. Data input 302 may be accessed by any number of organization-specific managerial applications to execute control business logic operable to compute a valuation. This may typically include fundraising control business logic 402, accounting control business logic 404, and program control business logic 406; but may also include N^{th} control business logic 408 which may constitute any desired managerial application specific to a client organization. The control business logic may be dynamic to accommodate specific managerial parameters. In an embodiment, the product of control business logic valuation (s) is accessed by an accounting application module or an accounting control module to execute accounting controls 410 and managerial controls 412. Accounting controls 410 executing over the accounting control module evaluate whether a reconciling difference exists between the accounting control valuation 410 and the managerial control valuation 412 or control business logic. Identified differences are flagged as reconciling items 306 and are available in a subsequent transactional report.

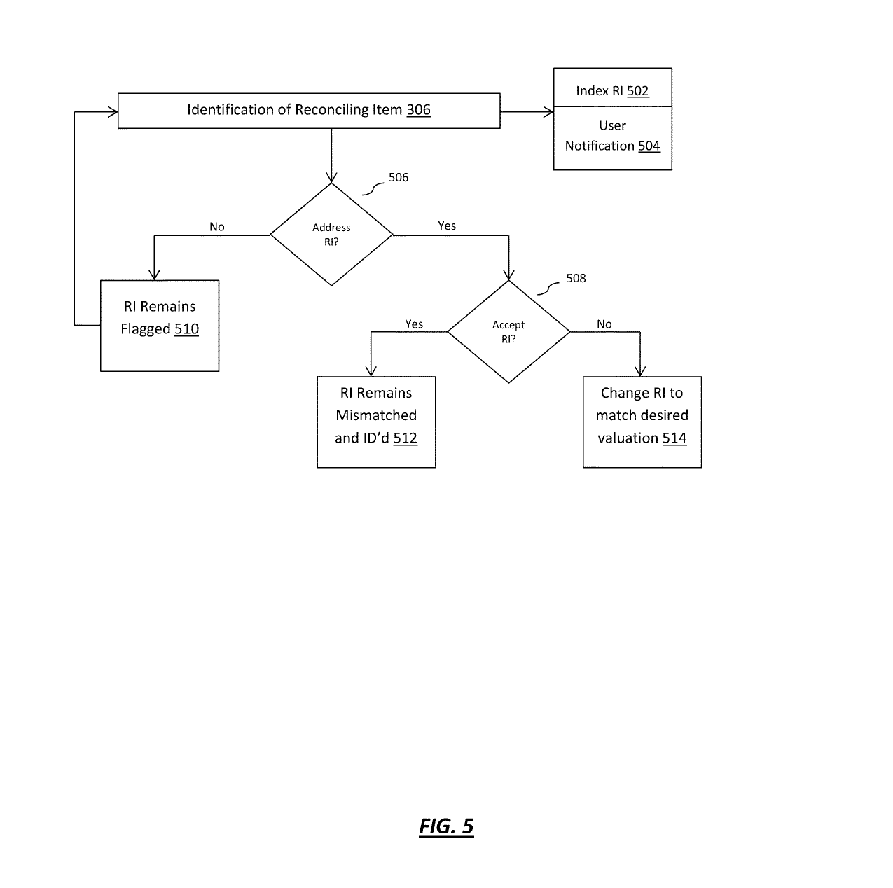

FIG. 5 is logical flow diagram illustrating a routine of an accounting reconciliation system in accordance with an embodiment. According to this embodiment, a reconciling item 306 is indexed 502 in an administrator reconciliation application or application module and made available to an end-user over a graphical user interface. The system may notify 504 a managerial or administrative user of the existence of reconciling item 306 over an electronic communication network such the user may elect to address the reconciling item 506 over the administrator reconciliation application. If the user does not address 506 the reconciling item, the reconciling item remains flagged 510 and is identified in transactional reports as a reconciling difference. If the user addresses 506 the reconciling item, the user is able to accept 508 the reconciling difference, or change the reconciling item to match the desired valuation 514. Accepted reconciling items remain mismatched and identified 512 in all subsequent transactional reports to illustrate the mismatched valuations. Reconciling items changed to match a desired valuation 514 are no longer flagged by the system as reconciling since the item now matching the accounting controls executed in the accounting application.

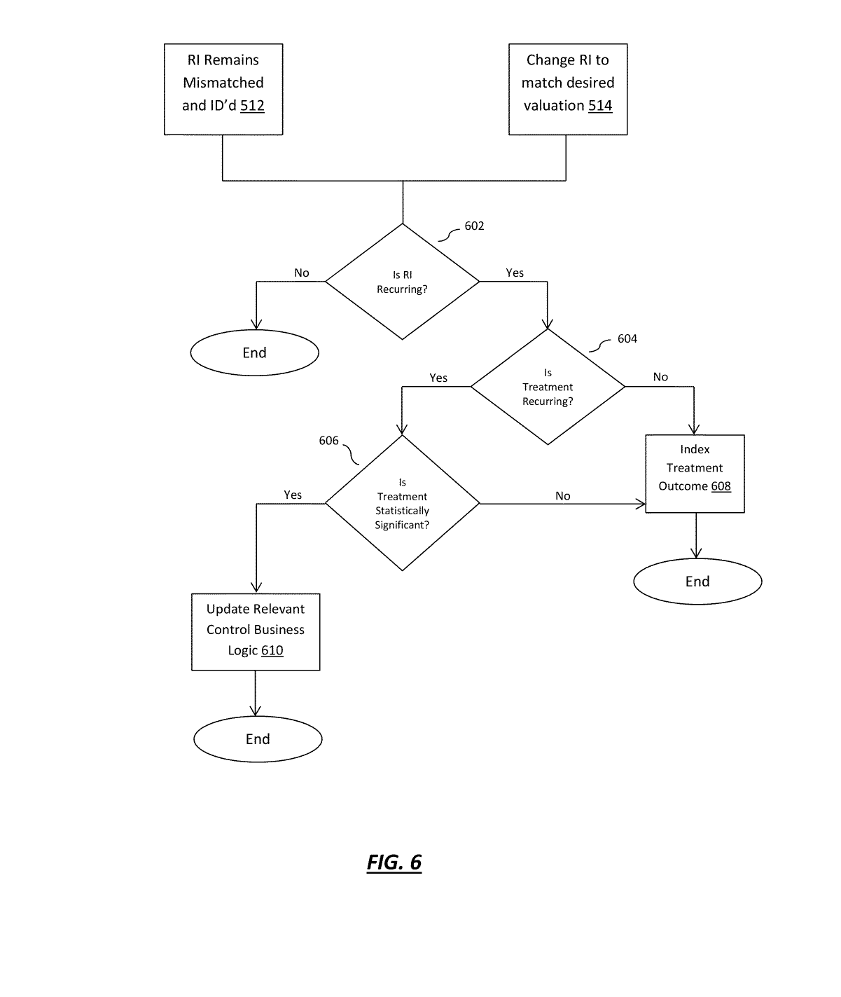

FIG. 6 is logical flow diagram illustrating a routine of an accounting reconciliation system in accordance with an embodiment. In accordance with this embodiment, recurring treatment of reconciling items may be evaluated by the system using self-configuring, instance-based learning controls to determine whether relevant portions of control business logic to account for future instances of reconciling items being generated under the same variables. Instance-based learning or memory-based learning may be comprised of a family of learning algorithms that, instead of performing explicit generalization, compare new problem instances with instances seen in training, which have been stored in memory. The system may evaluate a reconciling item outcome, which may include the reconciling item remaining mismatched and identified 512 or changing reconciling item to match a desired valuation 514, to determine whether the reconciling item is recurring 602. If the reconciling item is not recurring, no further action is taken and the reconciling item is not evaluated for instance-based learning. If the reconciling item is recurring, e.g. the existence of the reconciling item has occurred more than once under the same or similar parameters, the system evaluates whether the treatment of the reconciling item is recurring 604 by evaluating past treatment data points stored in the DTM or reconciling item index. If the treatment outcome is not recurring, the outcome is indexed 608 as a treatment data point for future reconciling item treatment evaluation. If the treatment outcome is recurring, the system evaluates whether the recurrence of the treatment is statistically significant as defined by the learning algorithms, the variables for which may be configured according to parameters determined by a client organization. If the treatment is statistically significant according to the system learning algorithms 606, the system is operable to update relevant portions of control business logic such that the control business logic accounts for future instances of reconciling items generated under the same variables to reduce or eliminate future reconciling items under the same parameters.

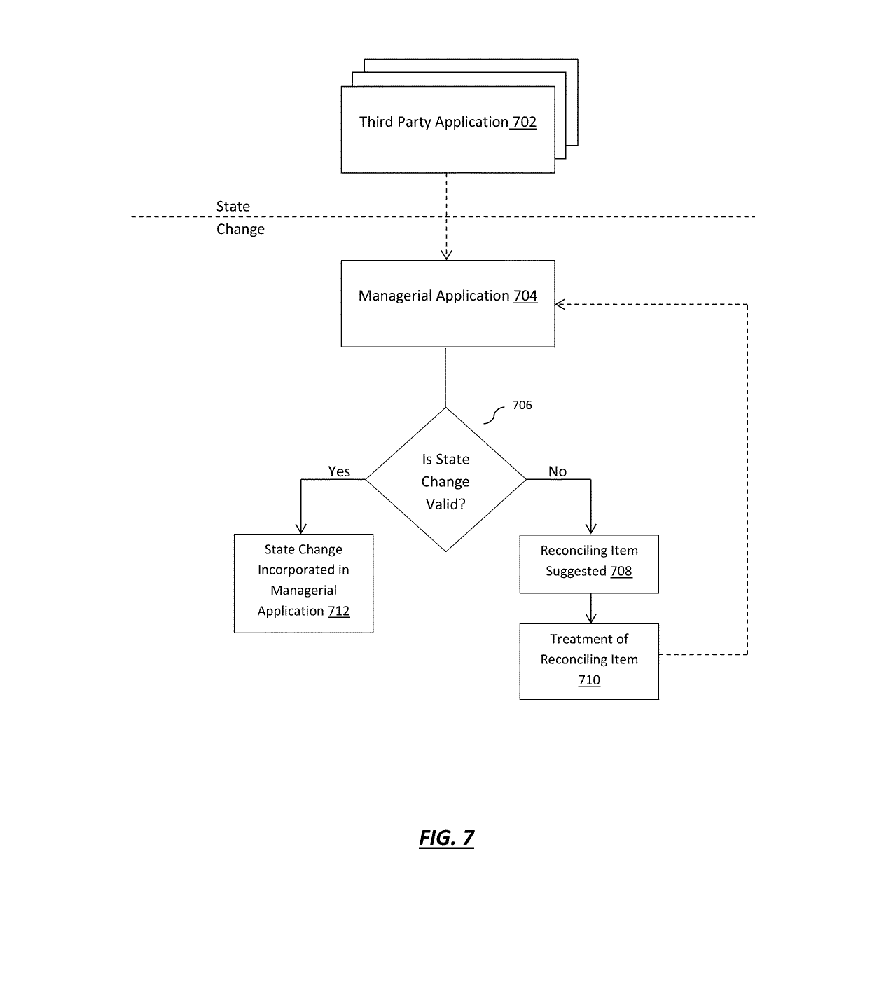

FIG. 7 is logical flow diagram illustrating a routine of an accounting reconciliation system in accordance with an embodiment. In accordance with this embodiment, a third party application 702 may be operable to communicate a state transition or state change to a managerial application 704. The state transition may correspond to recognition of revenue by a transaction service or processor. Upon recognition of a state transition, managerial application 704 is operable to evaluate whether the recognized state transition is valid 706. This is determined by evaluating the state transition against accepted managerial application patterns or DTM patterns. A reconciling item may be suggested 708 for gateway state transitions outside a DTM accepted pattern or other managerial application 704 accepted pattern. If a reconciling item is suggested 708 the managerial user will be able to select treatment of the reconciling item 710 such that the state transition may be accepted or rejected. If the state transition is valid, the state transition is incorporated 712 into managerial application for inclusion in a DTM or other relevant data module such that the revenue associated with the state transition is incorporated into the appropriate managerial and accounting application modules.

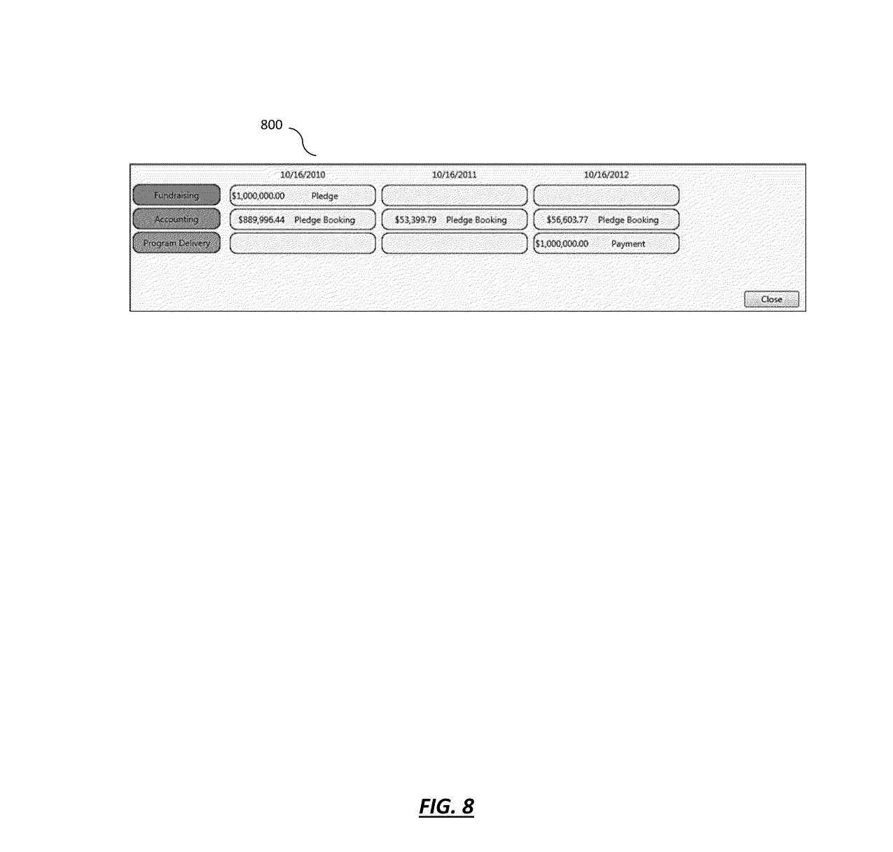

FIG. 8 is a diagram of a graphical user interface (GUI) for viewing function-based valuations across an accounting reconciliation system in accordance with an embodiment. In accordance with this embodiment, valuation view 800 illustrates acceptable differences in accounting valuations across a hypothetical non-profit organization. Valuation view 800 shows different managerial valuations across three departments: fundraising, accounting and program delivery. These valuations do not match, but are acceptable differences within the system because of the managerial control variables applied to each. In this example, the fundraising department applies accrual basis accounting controls to record an illustrative pledge of $1,000,000. In valuation view 800, the pledge is received on Oct. 16, 2010 and recorded the same day. The program delivery department applies cash basis accounting controls to record the actual payment of the $1,000,000 pledge on Oct. 16, 2012, even though the pledge was made on Oct. 16, 2010. The accounting department uses modified cash basis accounting controls to record the value of the pledge booking in each year of the pledge: $889,966.44 in 2010; $53,399.79 in 2011; and $56,603.77 in 2012. Valuation view 800 allows an end user to see how the competing valuations within the organization ultimately match at a given future date, in many cases the date when the total cash is received.

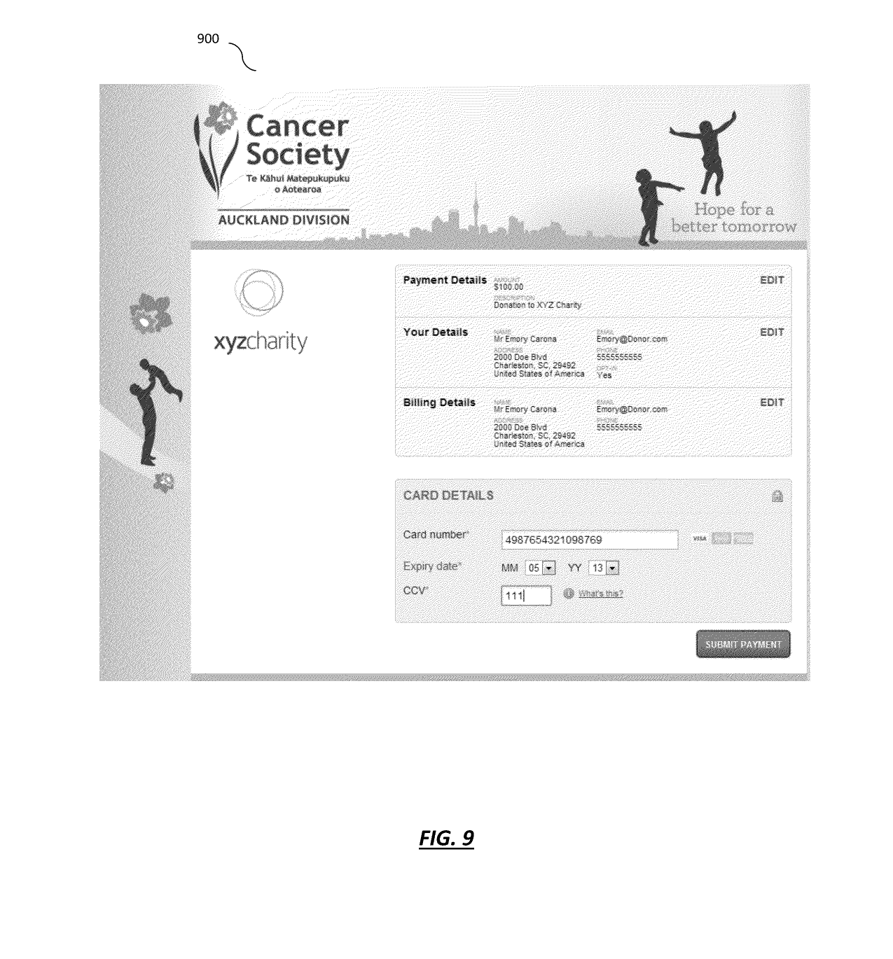

FIG. 9 is a diagram of a GUI for accepting a credit card donation over the Internet. In accordance with this embodiment, a donor may enter a donation using donation form 900. This will suggest a state transition between a gateway and a DTM to recognize the transaction event. In the context of a managerial and/or accounting application, an administrative user may be able to edit the donation in accordance with the given application's function logic. As an illustrative example, the administrative user may choose a date in a closed accounting period, in response to a legitimate need to enter a closed account period, to record and save the event. The accounting logic observes a managerial event in a closed period and communicates a reconciling item to a managerial user to resolve or accept.

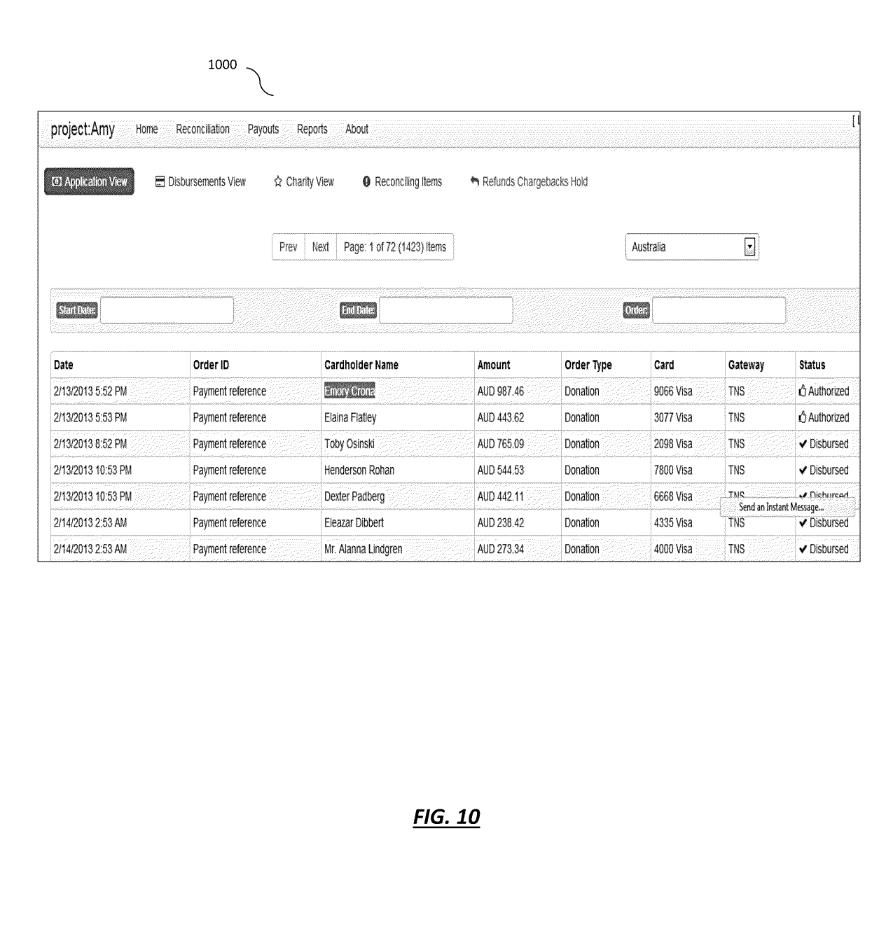

FIG. 10 is a diagram of a GUI for viewing an index of transaction events in an accounting reconciliation system in accordance with an embodiment. In accordance with this embodiment, a reconciliation interface 1000 enables a user to observe all transactions' reconciliation status between a managerial and accounting comparison and/or a gateway state transition to a DTM defined pattern. The donation from donation form 900 appears on the list of donors in reconciliation interface 1000. The transaction has an approved status, which means that the application saved the donation and the gateway responded with an authorization code as an acceptable state transition.

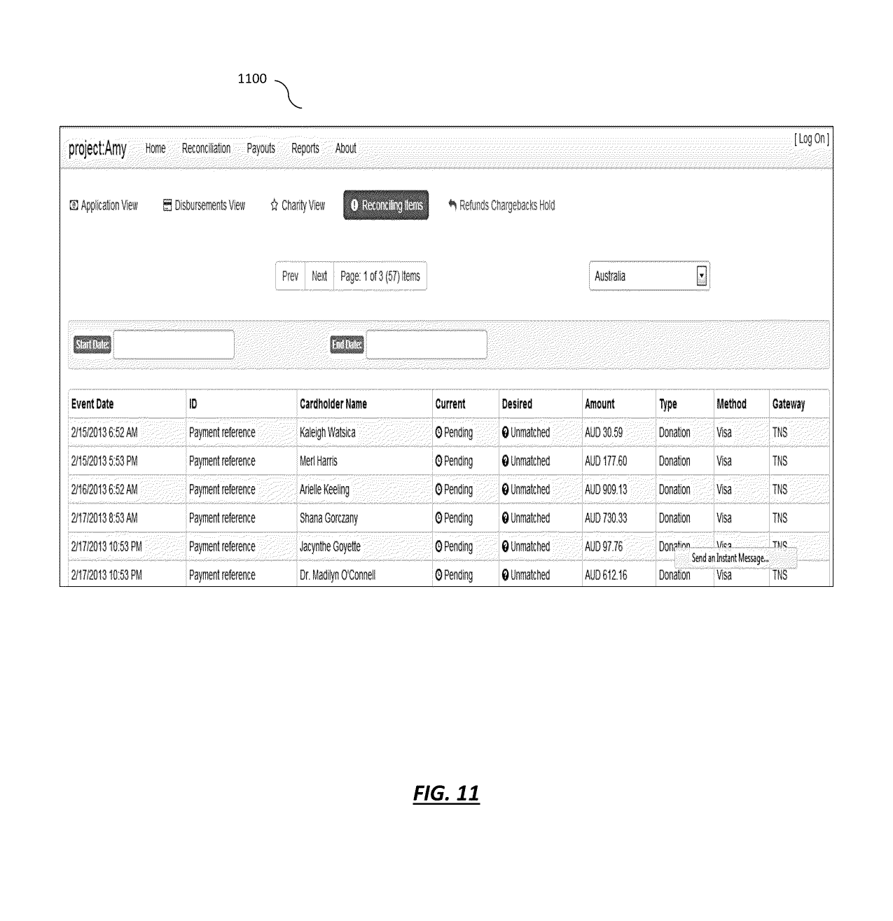

FIG. 11 is a diagram of a GUI for electing an action for a reconciling item in an accounting reconciliation system in accordance with an embodiment. In accordance with this embodiment, a reconciling items list 1100 enables a user to select an action for a reconciling item. Reconciling items list 1100 illustrates a difference between a current state versus expected state, meaning that the gateway returned a transition that did not meet a defined pattern. Managerial and accounting differences would also be displayed in reconciling items list 1100 for a user to select a relevant treatment outcome.

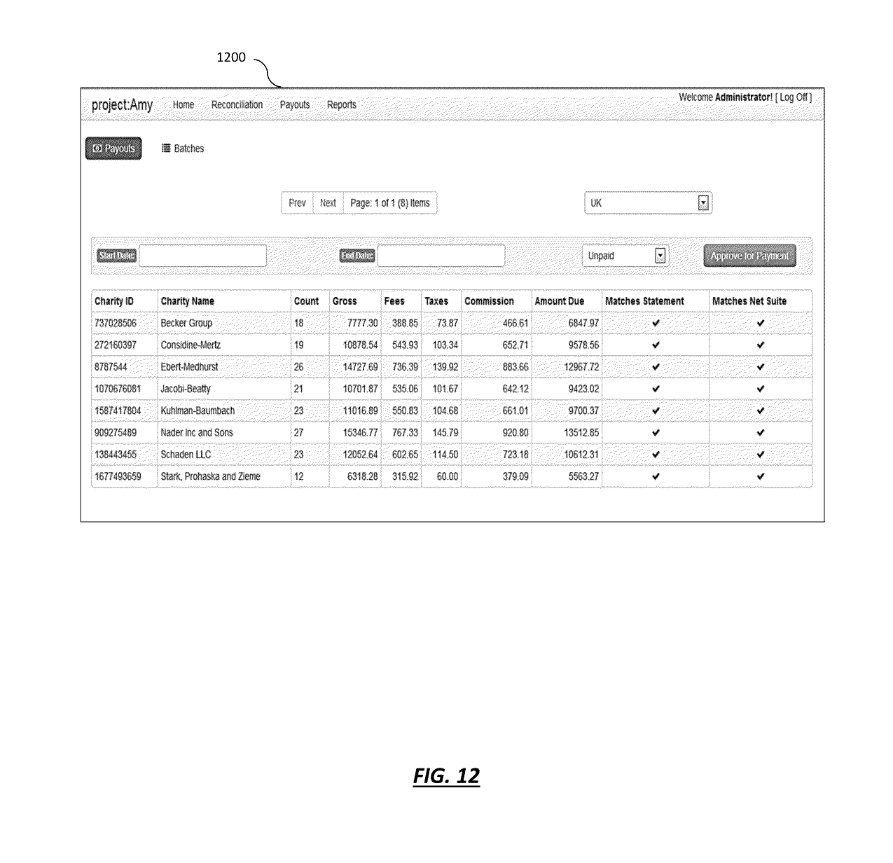

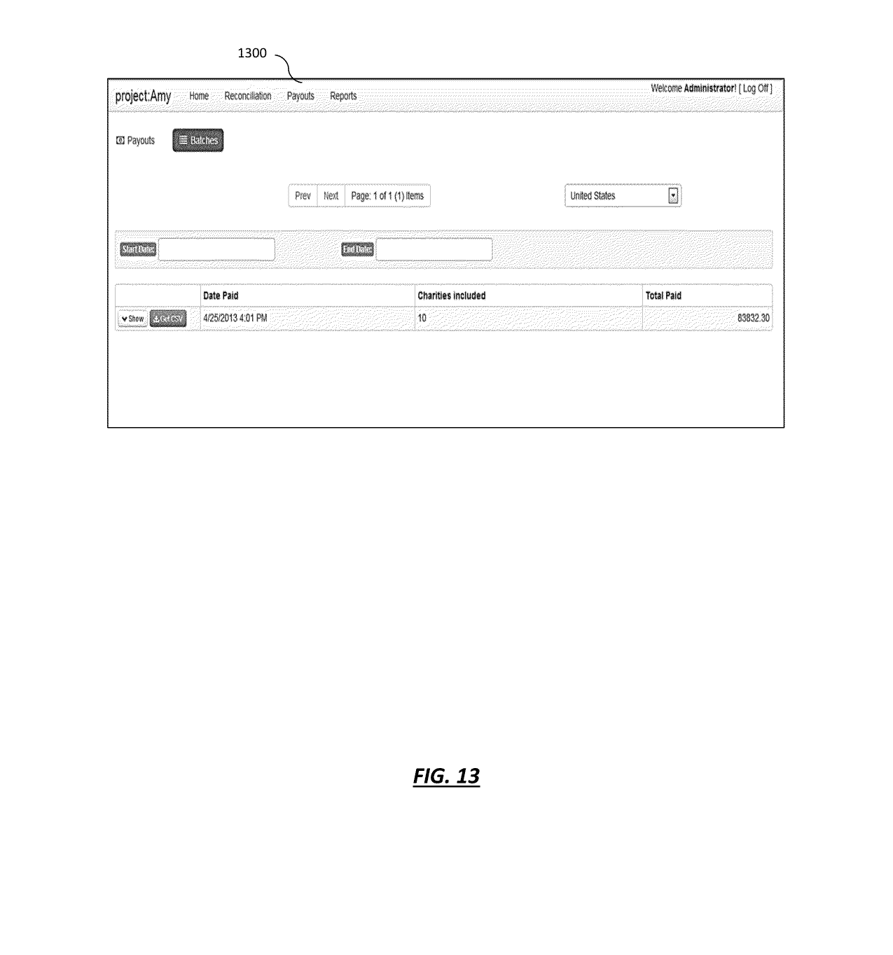

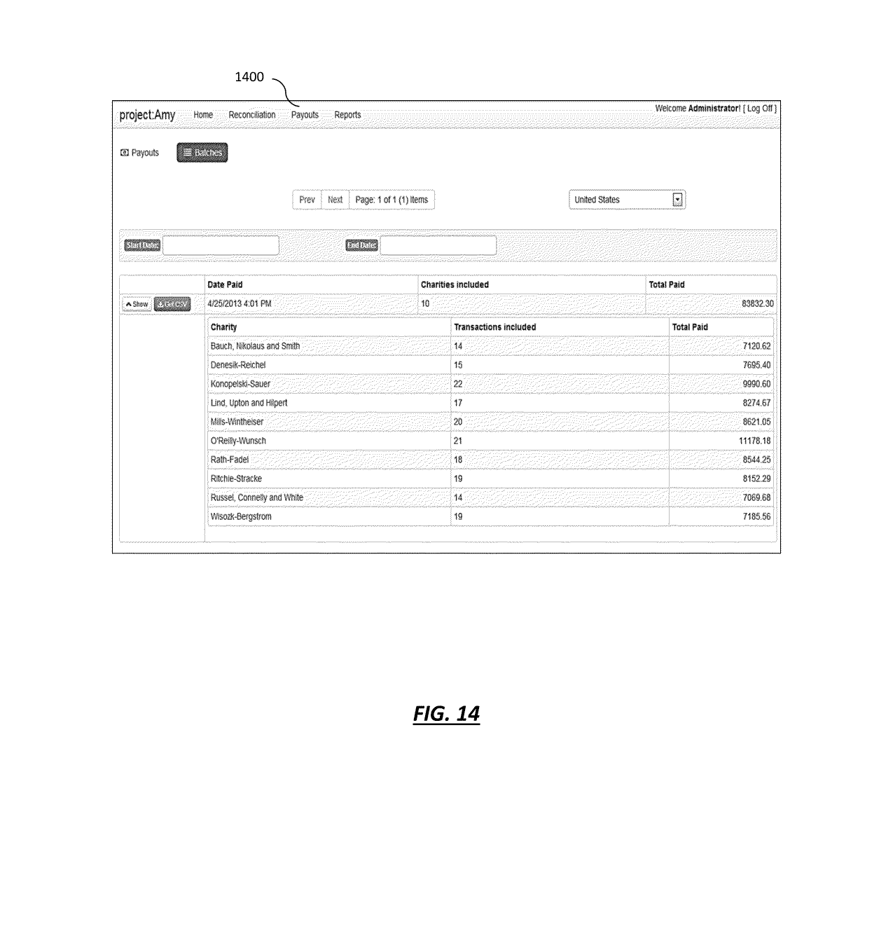

In an embodiment, accounting reconciliation system 200 is configured to reconcile vendor transactions for eventual disbursement to charity customers. FIGS. 12, 13, and 14 illustrate accounting reconciliation and payment processes in accordance with this embodiment. FIG. 12 is a diagram of a GUI for an agent payout approval in an accounting reconciliation system in accordance with an embodiment. A payout view 1200 illustrates payout details and allows a user to review and approve transactions prior to adding transaction to a batch payout. FIG. 13 is a diagram of a GUI illustrating a payout batch summary in an accounting reconciliation system in accordance with an embodiment. A batch payout view 1300 enables a user to review a summary of payment batches for a given jurisdiction. Customer statements and an accounts payable import file are available for viewing by a user. Transactions approved for batch payout view 1300 are reconciled and considered dispersed from the perspective of the DTM. FIG. 14 is a diagram of a GUI illustrating a comprehensive charity batch in an accounting reconciliation system in accordance with an embodiment. A paid batch details view 1400 illustrates a list of charities in an agent reconciliation and payment processing system. Paid batch details view 1400 allows a managerial user to view all charities within a given batch and the gross to net roll forward of those charities.

The embodiments described herein represent a number of implementation examples and are not intended to necessarily limit the present disclosure to any specific embodiments. Instead, various modifications can be made to these embodiments as would be understood by one of ordinary skill in the art. Any such modifications are intended to be included within the spirit and scope of the present disclosure and protected by the following claims.

What is claimed is:

1. A computer-implemented method for maintaining transactional integrity across managerial financial accounting applications, the method comprising:
receiving a data input corresponding to a transaction event, the data input being stored in a database;
executing a function-specific valuation based on the data input corresponding to the transaction event, the valuation being executed on a processor according to function-specific control business logic stored on a computer-readable medium, the function-specific control business logic being adapted to execute accounting controls and managerial controls;
identifying an instance of a reconciling item by comparing valuation outcomes between the function-specific control business logic and the accounting controls, the reconciling item being indexed in a database; and,
enabling a user to determine treatment of a reconciling item based on defined treatment parameters.

2. The computer-implemented method of claim 1 further comprising updating relevant portions of function-specific control business logic in response to statistically significant recurring reconciling items and recurring reconciling item treatment.

3. The computer-implemented method of claim 1 wherein the accounting controls are configured in accordance with generally accepted accounting principles.

4. The computer-implemented method of claim 1 further comprising communicating an electronic notification at least one identified user of an instance of a reconciling item.

5. The computer-implemented method of claim 1 further comprising aggregating accounting control outcomes across a plurality of function-specific valuations.

6. The computer-implemented method of claim 1 wherein the indexed reconciling items in the database are displayed over a graphical user interface on a permissive end user machine.

7. The computer-implemented method of claim 1 wherein the transaction event corresponds to a transaction selected from the group consisting of a donation, grant award, pledge, recurring gift, planned gift, matching gift claim, challenge gift claim, ticket sales, sponsorship, membership fees, merchandise sales, auction purchase, and service fees.

8. The computer-implemented method of claim 3 wherein the function-specific control business logic is adapted to execute dynamic modified cash basis accounting parameters selected by a user.

9. The computer-implemented method of claim 6 wherein the indexed reconciling items are actionable by the permissive end user over the graphical user interface.

10. The computer-implemented method of claim 9 further comprising updating a function-specific valuation in response to an action on an indexed reconciling item executed by the permissive end user in the database.

11. A system for preserving transactional integrity for managerial flexibility in financial accounting applications, the system comprising:
a memory device configured to store a data input corresponding with at least one transaction event, the memory device further configured to store and index reconciling items;
a processing device executing over one or more web servers configured to execute procedures of a managerial accounting integrity module, the module including:
logic configured to execute a valuation by function based upon the data input corresponding to the at least one transaction event, the function-specific control business logic being adapted to execute accounting controls and managerial controls;
logic configured to identify an instance of a reconciling item by comparing valuation outcomes between the function-specific control business logic and the accounting controls; and,
logic configured to determine a reconciling item outcome in response to a user input.

12. The system of claim 11 further comprising a network interface configured to enable communication between a client machine and the processing device, the client machine being configured to communicate accounting commands to the managerial accounting integrity module.

13. The system of claim 11 further comprising a merchant gateway executing over a third party application.

14. The system of claim 11 further comprising a data transfer mechanism configured to communicate a transaction event to a managerial application executing on the processing device.

15. The system of claim 11 wherein the managerial accounting integrity module further comprises logic configured to update a valuation by function in response to user action on a reconciling item.

16. The system of claim 11 wherein the accounting controls are configured in accordance with generally accepted accounting principles.

17. The system of claim 11 further comprising a client machine comprising a graphical user interface module for providing one or more graphical user interfaces enabling a user to enter or select managerial information and reconciling item information.

18. The system of claim 11 wherein the transaction event corresponds to a transaction selected from the group consisting of a donation, grant award, pledge, recurring gift, planned gift, matching gift claim, challenge gift claim, ticket sales, sponsorship, membership fees, merchandise sales, auction purchase, and service fees.

19. The system of claim 14 wherein the managerial accounting integrity module further comprises logic adapted to identify a valid state change between a merchant gateway and a data transfer mechanism.

20. The system of claim 15 wherein the reconciling items in the memory device are accessible to a permissive end user.

21. The system of claim 17 wherein the logic configured to determine a reconciling item outcome in response to a user input is further configured to update relevant portions of function-specific control business logic in response to statistically significant recurring reconciling items and recurring reconciling item treatment.

22. The system of claim 19 wherein the merchant gateway is selected from the group consisting of third party payment processors, automated clearing house transactions, stock, auction donations, and gift-in-kind.

23. A computer-readable media having financial reconciliation instructions stored thereon for preserving transactional integrity in managerial accounting applications, the financial reconciliation instructions being executable by a processor, the financial reconciliation instructions comprising:
logic adapted to execute a plurality of function-specific valuations, the plurality of function-specific valuations being defined by a data input corresponding to a transaction event and control business logic, the control business logic being adapted to execute managerial and accounting control valuations;
logic adapted to identify reconciling items across the plurality of function-specific valuations, the reconciling items being identified by comparing control business logic outcomes against managerial control valuation outcomes;
logic adapted to identify a valid state change between a merchant gateway and a data transfer mechanism; and,
logic adapted to enable a user to view and act upon identified reconciling items such that the user may select a treatment outcome for the identified reconciling items, and may update relevant portions of the control business logic in response to statistically significant recurring reconciling items.

24. The computer-readable media of claim 20 further comprising a graphical user interface module adapted to provide one or more graphical user interfaces enabling a user to enter or select managerial information and reconciling item information.

25. The computer-readable media of claim 20 further comprising logic adapted to identify a valid state change between a third party application and a managerial application.

26. The computer-readable media of claim 20 wherein the managerial control valuations of the control business logic is defined by a managerial end-user input.

27. The computer-readable media of claim 20 wherein the transaction event corresponds to a transaction selected from the group consisting of a donation, grant award, pledge, recurring gift, planned gift, matching gift claim, challenge gift claim, ticket sales, sponsorship, membership fees, merchandise sales, auction purchase, and service fees.

28. The computer-readable media of claim 24 further comprising logic adapted to index instances and treatment outcomes of reconciling items in a database.

29. The computer-readable media of claim 28 further comprising logic adapted to:
send an electronic notification to an end-user upon identification of the instances and treatment outcomes of reconciling items in the database;
post outcomes to a third-party general ledger;
receive a posted status in an integrated model application; and,
post reconciling item candidates for a resolved status for a system transaction.

30. The computer-readable media of claim 29 wherein the graphical user interface module is further adapted to enable the end-user to select a treatment action in response to the electronic notification.
